(19) United States
(12) Patent Application Publication
(10) Pub. No.: US 2006/0069815 A1
(43) Pub. Date: Mar. 30, 2006

(54) Method and system for initiating a task and receiving task data via TWAIN interface from network-attached peripheral

(76) Inventors: William Thomas Warner III, Lexington, KY (US); Timothy Gerard Yorkey, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/954,814

(22) Filed: Sep. 29, 2004

(51) Int. Cl. G06F 3/00

(52) U.S. Cl. 710/10

(57) ABSTRACT

Methods and systems are described for acquiring data from a peripheral and transferring the data to a host via a network. A disclosed method includes creating and storing a job profile at a host and retrieving and executing the subject job at a selected peripheral. The parameters for executing the job are stored with the job profile and the profile is retrieved from the host at the peripheral via the network. Data is acquired at the peripheral and transmitted to the host in accordance with the TWAIN protocol where it is made available to one or more applications running on the host.

### BACKGROUND OF THE INVENTION

The present invention relates to communications between a host computer and computer peripherals and, more particularly, to methods and systems for communicating with scanners or similar peripherals using a TWAIN interface.

General-purpose, personal computers (such as computers that run Microsoft Windows or Apple Computer operating systems) may be connected to a variety of peripherals, such as printers, scanners, cameras, etc. In general, communications with such peripherals require use of software known as a driver. The driver software serves as a communication link between an application program (such as a word processing program or image editing program) and the peripheral. Peripherals designed to capture images (e.g., scanners) are often designed to communicate according to a standard language or protocol known as TWAIN (sometimes referred to as “technology without an interesting name”). A TWAIN driver acts as an interpreter between any application that supports the TWAIN standard interface (e.g., Adobe Photoshop software) and a peripheral (e.g., a scanner).

Current approaches for using a network peripheral, such as a scanner, attached to a personal computer or workstation generally fall into two categories. The first category treats the network peripheral as if it were locally attached to the workstation. This approach tends to ignore the complications involved in using a device that is shared with many workstations. Concurrence and communication failures are generally ignored in systems included in the first category. For example, multiple users may simultaneously submit requests to a single peripheral and timing and scheduling must be performed to properly handle the requests. The user is also required to know the specific peripheral to use to perform the requested task. If a selected peripheral is shut down or off-line, in an error condition (e.g., paper jam), or a long line of other users are waiting to use the peripheral, the user may be required to resubmit the job at a workstation and select a different peripheral.

The second category treats the network peripheral as separate from a workstation. This approach involves performing a task, such as a scan, at the peripheral and then sending the data involved in the task to a workstation where it will be used. A drawback here is that the process is not fully integrated with an application running on the workstation. For example, the user must typically perform two steps to import acquired data into an application executing on a workstation. First, the user must perform a data acquisition task at the peripheral. Once the first step is completed, the user must then move to the workstation and launch the application that will be used to import or retrieve the data from the peripheral. Because the application oftentimes requires that the received data be formatted in a particular way, if the data received from the peripheral is not formatted correctly, the user is forced to repeat the foregoing steps.

An unsatisfied need therefore exists for improved methods and systems of communicating with networked peripherals using TWAIN interfaces.

### SUMMARY OF THE INVENTION

One embodiment of the invention provides a method of acquiring data from a target device and transferring the data to a host device. The method may include requesting, on the host device, an acquisition of data by a target device, such as a scanner or other peripheral; obtaining, on the host device, acquisition parameters; and storing a profile including the acquisition parameters on the host device. The method may also include selecting the profile on the target device (e.g., a scanner) and retrieving the profile from the host device. Retrieving the profile from the host device may initiate the establishment of a communication channel. The communication channel allows data and commands to be sent between the host computer and the target device. The target device then executes the acquisition of data requested using the acquisition parameters to obtain acquired data and delivers the acquired data over the communication channel to the host computer. The host computer then forwards the acquired data to an application program running on the host computer.

Another embodiment provides a system for acquiring data from a target device. The system includes a host computer that is configured to initiate a task, to obtain task parameters, to store a profile including the task parameters, to establish a communication channel with the target device, and to acquire data from the target device. The system also includes a target device configured to display a list of profiles stored on the host computer, to retrieve the selected profile from the host computer, to execute the task based on the task parameters included in the profile to obtain acquired data, and to transmit the acquired data to the host computer, at which point it is incorporated into an application running on the host computer.

Other embodiments provide a system for acquiring data from a device. The system includes a plurality of host computers, where each one of the plurality of host computers is configured to initiate a task, to obtain task parameters, to store a profile including the task parameters, to establish a communication channel with the device, and to acquire data from the device. The system also includes a network configured to connect the plurality of host computers to the target device and a target device, such as a scanner, configured to display a plurality of profiles stored on the plurality of host computers, to retrieve a profile from one of the plurality of host computers, to execute the task based on the task parameters included in the profile to obtain acquired data, and to transmit the acquired data to one of the plurality of host computers, at which point it is incorporated into an application running on the host computer.

Yet another embodiment provides a computer-readable medium containing instructions for acquiring data from a peripheral by: requesting an acquisition of data; obtaining acquisition parameters; storing a profile including the acquisition parameters on the host device; selecting the profile; retrieving the profile from the host device; establishing a communication channel; executing the acquisition of data request based on the acquisition parameters to obtain acquired data; delivering acquired data over the communication channel; and sending the acquired data to an application program.

Other features and advantages of the invention will become apparent to those skilled in the art upon review of the following detailed description and drawings.

### BRIEF DESCRIPTION OF THE DRAWINGS

In the drawings:

FIG. 1 illustrates a four-layer model of a TWAIN architecture.

FIG. 2 illustrates a communication between an application program, a Data Source Manager, and a Data Source.

FIG. 3 illustrates a system in which a plurality of computers are connected to a plurality of peripheral devices via a network.

FIG. 4 is a flow chart that illustrates a data transfer process in accordance with one embodiment of the invention.

FIG. 5 illustrates a user interface that may be presented to a user.

It is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

### DETAILED DESCRIPTION

Before embodiments of the invention are described in detail a brief review of the TWAIN protocol is provided. Nonetheless, it is assumed that the reader is familiar with the TWAIN specification (which is referenced below).

As noted, TWAIN is a standard protocol for communicating with peripherals and, most often, scanners. The TWAIN standard also specifies an application programming interface for communicating with application software and, what is called, “Data Source” software. Application software can be an imaging application, word processing application, or the like running on a personal computer. The Data Source software refers to driver software installed on a personal or other computing device (sometimes referred to as a “host computer”) to which a peripheral or source of information (such as a digital camera, scanner, or image database) is connected. The term “host computer” or “computer” is referred to herein in a generic sense and should be understood to encompass any general purpose data processing machine.

TWAIN communications involve three main components in a host computer: application software, what is called “Source Manager” software, and Data Source software. The application software acquires images or other data in accordance with the TWAIN specification (see, http://www.twain.org/docs/Spec1_{—}9_{—}197.pdf). The Source Manager software manages the interactions between the application software and the one or more installations of Data Source software. The Source Manager software may be a component of an operating system. The Data Source software controls the peripheral (e.g., an image acquisition device). In a TWAIN-compatible system, the communication among these three components follows the TWAIN specification.

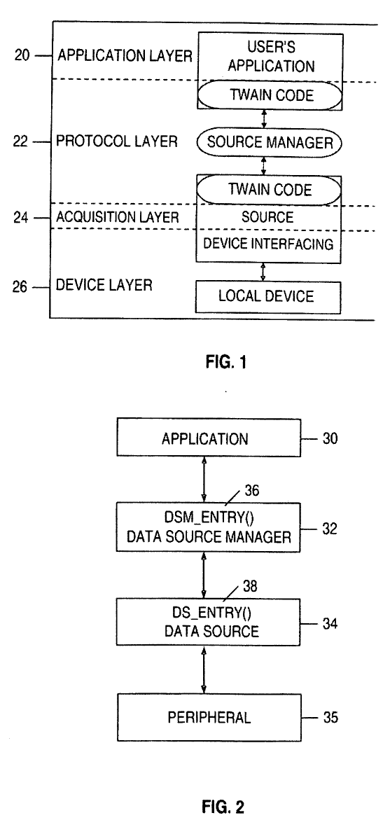

Exemplary interactions of these components are illustrated in FIGS. 1 and 2. As shown in FIG. 1, an exemplary TWAIN compliant connection between a computer and a peripheral occurs across four framework layers: an application layer 20, a protocol layer 22, an acquisition layer 24, and a device layer 26. The application layer 20 defines the communication syntax and models execution of application software. The protocol layer 22 specifies the syntax and semantics of the TWAIN specification. The acquisition layer 24 defines and provides a mechanism for controlling the acquisitions of physical or logical devices by a Data Source software. The device layer 26 defines and provides conventional low-level device drivers.

FIG. 2 illustrates the communication among application software 30, Data Source Manager software 32, Data Source software 34, and a peripheral 35. In general, the communication occurs through two entry points in accordance with the TWAIN specification. The two entry points are function calls DSM_Entry( ) 36 and DS_Entry( ) 38. As used herein, “DSM” refers to Data Source Manager software and “DS” refers to Data Source software. As shown below, the application software 30 and Data Source software 34 communicate to the Source Manager software 32 using these function calls. When the application software 30 requests data from the peripheral 35, the application software 30 uses the DSM_Entry( ) 36 to communicate with the Data Source Manager 32. The Data Source Manager 32 then communicates with a specific Data Source software 34 that corresponds to the peripheral 35 using the DS_Entry( ) function 38. Typically, the Data Source software 34 controls the peripheral 35 and instructs the peripheral 35 to acquire data as requested by the application software 30. The Data Source software 34 obtains the data acquired by the peripheral 35 and forwards the data to the Data Source Manager 32 through the DSM_Entry( ) function 36. The Data Source Manager 32 then provides the acquired data to the application software 30 that requested it.

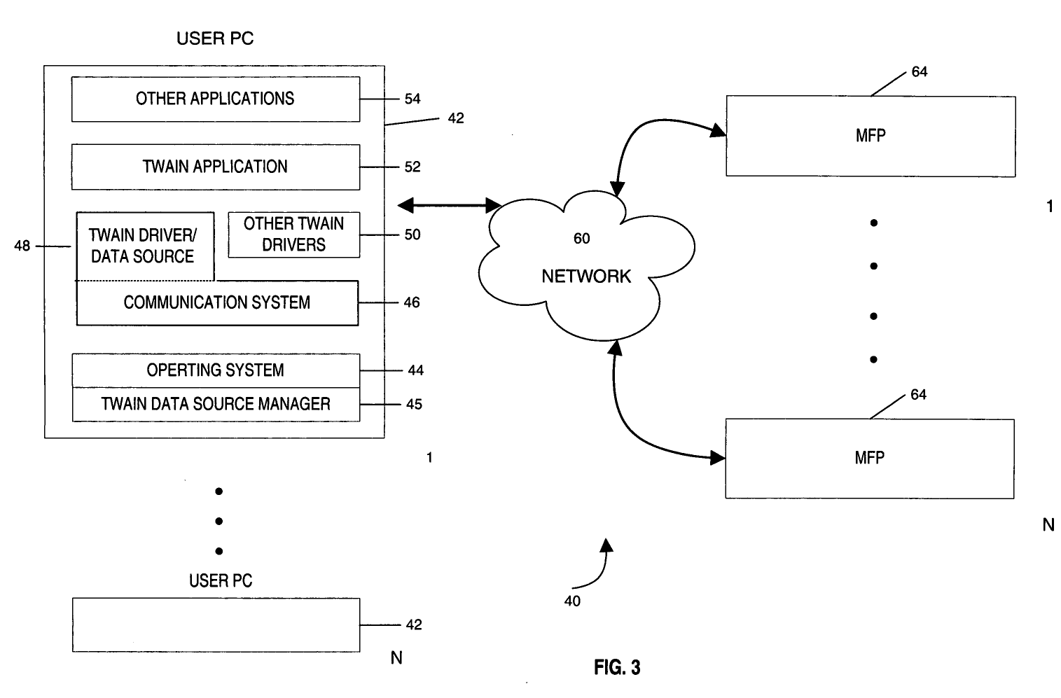

FIG. 3 illustrates an exemplary system 40 constructed according to one embodiment of the invention. The system 40 includes a plurality of host devices or computers 42. The computer 42 near the top, left-hand corner of FIG. 3 is illustrated in detail and, as shown, includes an operating system 44 having a Data Source Manager 45, a communication system software 46 (or manager), and a TWAIN driver/Data Source 48. The communication system software (or manager) 46 and TWAIN driver/Data Source 48 are shown as being parts of a single component, which, in a broad sense, performs the job of a driver. It should be noted that there could be multiple TWAIN drivers/Data Sources 48 loaded on the computer 42 and that the respective TWAIN Data Sources can be configured as separate from the communication system software 46.

The computer 42 may also include a plurality of other TWAIN drivers 50 (represented schematically) configured according to the prior art, for one or more TWAIN-compliant applications 52 (such as Adobe Photoshop, Microsoft Word, and other similar software), and a variety of other application software 54.

The computers 42 may include or be connected to a variety of common components and devices such as a monitor or display, keyboard, cursor-control device (e.g., a mouse, joystick, or touch screen), speakers, microphone, disk drive, solid-state memory and the like. In an embodiment, the operating system is software that is available from Microsoft, Apple and other commercial software distributors, or the OS may be one of several operating systems that are freely distributed. The communication system software 46 may be proprietary software distributed by a peripheral manufacturer such as Lexmark International, Inc., or it may be communication software that is compatible with the peripherals and available from sources other than the peripheral manufacturer. Although the details of the operation of such software are not always known, the software required to communicate with a peripheral and/or that interfaces with a TWAIN driver is generally available and the implementation of such software is within the ability of one of ordinary skill in the art.

With reference to FIG. 3, each of the computers 42 is shown connected to a network 60. The network 60 may be a local area network (“LAN”) or wide area network (“WAN”) supporting protocols such as UDP/IP, TCP/IP, IEEE 1394, USB, and IEEE 802.11. A plurality of target devices or peripherals 64, such as the illustrated multi-function peripherals (“MFP”) (devices that incorporate a scanner, printer, and copier in a single housing (also known as all-in-one (“AIO”) devices)) may be connected to the network 60. FIG. 3 illustrates a plurality of MFPs connected to the network 60, but one of ordinary skill will readily recognize that any number of peripherals and peripheral types such as cameras, printers, disk drives, storage devices, and the like could be connected to the network as well. Most every peripheral will likely include a variety of well-known features such as a display (e.g., an LCD display) to visually present information to a user and input mechanisms (such as key pads and buttons) to allow a user to interact with the various peripheral devices.

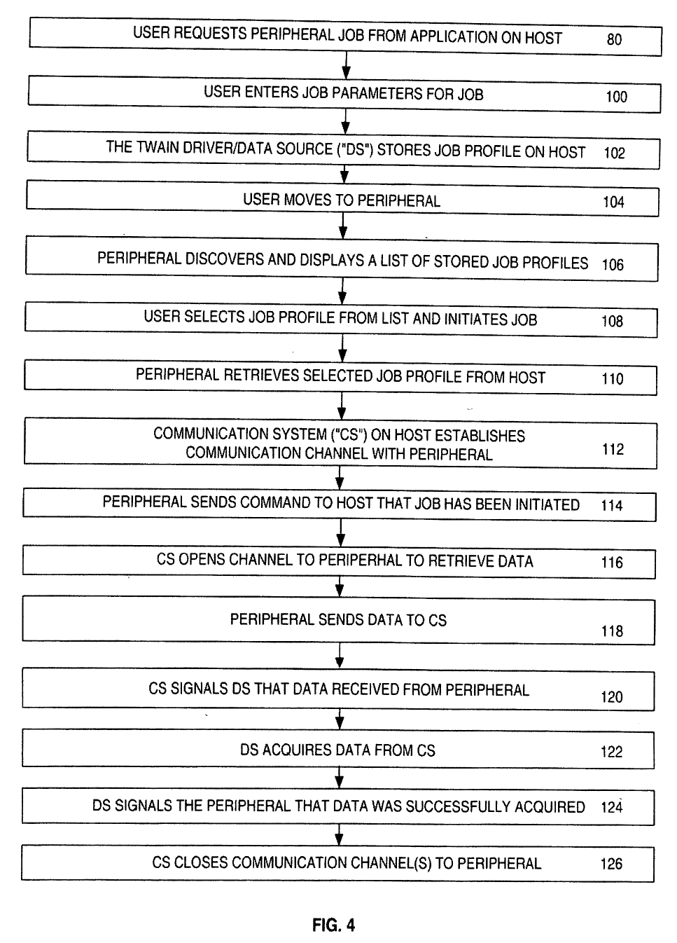

In an embodiment, the system 40 is configured such that a user can initiate a task at one of the computers 42 without specifying a particular peripheral 64 that will be used to perform the task. An embodiment thus allows the user to initiate a request at one computer 42 and to then to select from the plurality of peripherals 64 connected to the network 60 that will be used to retrieve or “pull” the request from the computer 42. This might be beneficial, for example, if the user does not know which of the available networked peripherals will be in use when the user needs to retrieve the request from the computer 42. The overall process is illustrated in FIG. 4 and described below.

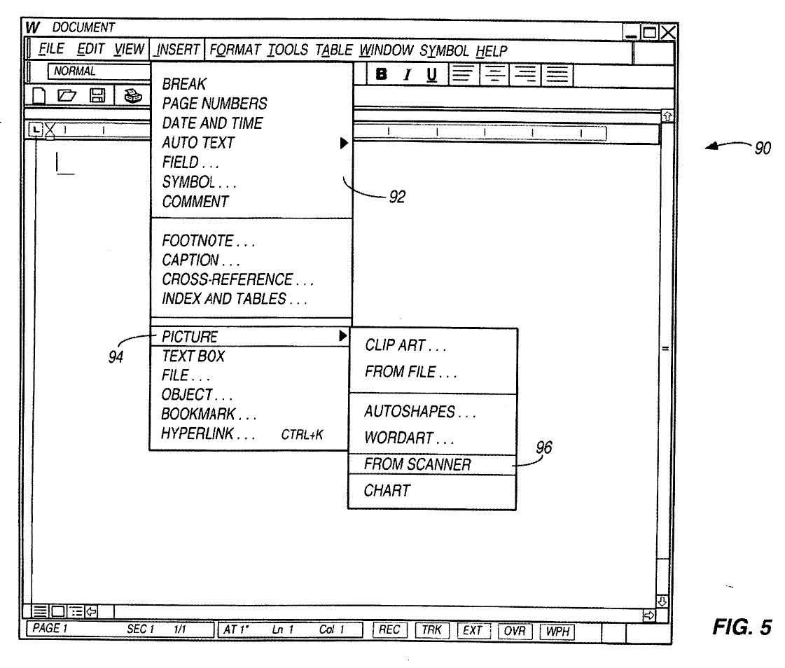

In an exemplary embodiment, the process begins with a user accessing an application interface on a computer 42 to start a task (step 80). An exemplary user interface 90 (generated, for example, by the operating system 44 and one of the application programs 54) is shown in FIG. 5. In this example, the user clicks though several menu options (insert menu 92, picture option 94, and a “From Scanner” option 96) to indicate to the application that the user intends to scan an image from a scanner peripheral.

As part of the process, the user optionally specifies one or more acquisition parameters or options for operating the target peripheral (step 100), which in this case is a scanner that may or may not be part of a MFP. Examples of the parameters that nay be entered at this point in the process include, but are not limited to paper size, image resolution, color, depth and the like. In some cases, the parameters that are entered at this point may be specific to a particular brand, type, category or line of peripheral, while other parameters may have applicability across various peripheral types. As one example, at step 100 a user might enter several resolution parameters that correspond to one or more of the plurality of peripherals 64 connected to the network 60. When executing the task (described below) the particular resolution of the entered parameter(s) may depend on the peripheral 64 selected to perform the task and the peripheral that will be selected may or may not be known to the user at the time the parameter was entered.

The user's choice of parameters may also limit the types of peripherals that can be used to execute the job. For example, the user may require an image resolution that is higher than the resolution that is available on some of the plurality of available peripherals. The application may also include error checks that notify a user if the user enters two parameters that are inconsistent, or if the user enters a parameter that cannot be satisfied by any of the peripherals available on the network. Alternatively, an error check may be performed at the time that the task is executed, or still alternatively, a peripheral 64 may default to another (or next best) setting if none of the available peripherals satisfy the parameters set by the user. In such case, a warning message may optionally be generated to notify the user of the change in setting(s).

After the user has entered parameters for a task or job, the TWAIN Data Source (“DS”) 48 stores a task or job profile on the computer 42 at step 102. The job profile may include the parameters supplied by the user, and can also include a user identifier and/or host computer name to link the profile to a particular user or computer 42.

In some embodiments, the user is then prompted via a graphical user interface element, text message or other means (such as a sound, etc.) to proceed to one of the plurality of peripherals 64 (step 104) and perform any appropriate task preparation (such as placing an item to be scanned in the scanner of the selected peripheral 64). Again, in some embodiments, this prompting process may identify the peripherals or the locations of the peripherals that satisfy the parameters entered by the user. In addition, when appropriate the interface may optionally provide an indication if the user has entered one or parameters that cannot be satisfied by the networked peripherals. In an alternative embodiment, the computer 42 does not have access to the technical specifications and capabilities of every networked peripheral and does not offer this level of detail to the user.

At step 106, the user selects one of the networked peripheral and the peripheral retrieves a list of available job profiles. In some embodiments, the peripheral retrieves all of the available job profiles (or at least all job profiles associated with that user). The retrieval process may retrieve job profiles from all networked computers or, alternatively, may display a list of available computers and/or prompt the user to identify a computer. The list of available computers may include computers that have stored job profiles, or stored profiles capable of being executed by the peripheral, the entire plurality of computers 42 connected to the network 60, or some subset of these options. In an embodiment, the user selects an available computer, and the peripheral device retrieves and displays to the user a list of job profiles retrieved from the selected computer.

The list of available computers and/or job profiles is displayed on a peripheral or on a separate display device associated with the peripheral. In an embodiment, the available job profiles are saved on one or a plurality of computers 42 connected to the network, and the chosen peripheral is configured to retrieve job profiles from these networked computers. In one embodiment, a peripheral 64 is configured to filter the list of available profiles such that only those job profiles that the peripheral is capable of executing are displayed. Job profiles that have parameters that cannot be satisfied by the peripheral 64 may not be listed or may be listed but “grayed out”. Alternatively, a peripheral 64 may display all available job profiles (or all available job profiles associated with that user), but will generate an error message if the user selects a job profile having parameters that the peripheral 64 cannot fulfill. When the user is ready to initiate a task (such as scanning a document), the user selects the appropriate job profile from the displayed list (step 108).

When the user selects a job profile, the peripheral retrieves the selected job profile from one of the computers 42 (step 110). At step 100, a communication link is established with the selected peripheral, which, in one embodiment, causes the communication system (“CS”) software 46 on the computer 42 to initiate or open a communication channel with the peripheral 64 (step 112). At step 114, the peripheral 64 sends a command to the computer 42 that identifies the job profile or task that has been initiated. At step 116, the CS software 46 on the computer 42 prepares to receive data from the peripheral. Activities that can occur at step 116 optionally include establishing or configuring a data retrieval channel, allocating buffer memory, and gaining a handle to a file to store the data.

After the data retrieval preparation is complete, the subject task is performed at the peripheral (such as a scan) and the data acquired by the task is sent to the computer 42, as shown in step 118. The CS software 46 receives the acquired data and sends a signal to the TWAIN DS 48 indicating that data was received (step 120). The TWAIN DS 48 then retrieves the acquired data from the CS software 46, as shown in step 122. The TWAIN DS 48 may send the acquired data to the application on the computer 42 that requested the job.

At step 124, the TWAIN DS 48, using the communication channel, signals the peripheral 46 that the data was successfully retrieved. In step 126, after the last packet of data is received, communications with the peripheral are terminated (communication channel(s) are closed) and the transfer of data from the peripheral to the CS software 46 and TWAIN DS 48 ends. The job profile used by the peripheral may be removed from the computer 42 or may remain on the computer 42 where it can be retrieved by subsequent jobs on the previously selected peripheral or other peripherals 64 connected to the network 60.

The foregoing process description is intended to be illustrative and one of ordinary skill in the art will readily recognize that some or all of the identified steps may be omitted, combined or may occur in a sequence different from that described in accordance with different embodiments of the present invention.

As should be apparent to one of ordinary skill in the art, the systems shown in the figures are models of what actual systems might be like. Many of the components and logical structures described are capable of being implemented in software executed by a microprocessor or a similar device or of being implemented in hardware using a variety of components including, for example, application specific integrated circuits (“ASICs”). Furthermore, throughout the specification and claims, reference is made to various user interfaces. Although these interfaces are sometimes described as graphical in nature, it should be understood that other kinds of interfaces, such as audio or touch-sensory interfaces could be provided and that such interfaces could be implemented by those of ordinary skill in the art. Thus, unless specifically indicated otherwise, the claims should not be limited to graphical interfaces or to any specific hardware or software implementation or combination of software or hardware. In addition, capitalized terms, such as “Data Source” are used. Use of such terms is made to be consistent with common industry practice. Nothing, however, should be construed as limiting the breadth of such terms merely because they have been capitalized.

Various features and advantages of the invention are set forth in the following claims.

What is claimed is:

1. A method of acquiring data at a target device and transferring the data to a host device, the method comprising:
requesting, on the host device, an acquisition of data;
obtaining, on the host device, acquisition parameters;
storing a profile including the acquisition parameters on the host device;
selecting, on the target device, the profile;
retrieving the profile from the host device;
establishing a communication channel;
executing the acquisition of data request based on the acquisition parameters to obtain acquired data; and
delivering acquired data over the communication channel to the host device.

2. A method as claimed in claim 1, further comprising transferring the acquired data from a communication system on the host device to a data source.

3. A method as claimed in claim 1, further comprising sending the acquired data to an application program executing on the host computer.

4. A method as claimed in claim 1, further comprising signaling the target device that the acquired data was received.

5. A method as claimed in claim 1, further comprising closing the communication channel.

6. A method as claimed in claim 1, further comprising creating a list of available host devices including the host device.

7. A method as claimed in claim 6, further comprising presenting, on a target device, the list of available host devices.

8. A method as claimed in claim 6, further comprising providing a user interface for selecting the host device from the list of available host devices.

9. A method as claimed in claim 8, further comprising selecting the host device from the user interface.

10. A method as claimed in claim 1, further comprising creating a list of available profiles including the profile.

11. A method as claimed in claim 10, further comprising presenting, on the target device, the list of available profiles.

12. A method as claimed in claim 10, further comprising filtering the list of available profiles.

13. A method as claimed in claim 1, further comprising obtaining a host name of the host device.

14. A method as claimed in claim 13, further comprising including the host name with the profile.

15. A method as claimed in claim 10, further comprising sending the acquired data to an application program executing on a host computer identified by the host name included in the profile.

16. A system for acquiring data from a target device, the system comprising:
a host computer configured to initiate a task, to obtain task parameters, to store a profile including the task parameters, to establish a communication channel with the device, and to acquire data from the device;
the target device configured to display a list of profiles stored on the host computer, to retrieve the profile from the host computer, to execute the task based on the task parameters included in the profile to obtain acquired data, and to transmit the acquired data to the host computer.

17. A system for acquiring data from a target device, the system comprising:
a plurality of host computers, each one of the plurality of host computers configured to initiate a task, to obtain task parameters, to store a profile including the task parameters, to establish a communication channel with the target device, and to acquire data from the target device;
a network configured to connect the plurality of host computer to the target device; and
the target device configured to display a plurality of profiles stored on the plurality of host computers, to retrieve a profile from one of the plurality of host computers, to execute the task based on the task parameters included in the profile to obtain acquired data, and to transmit the acquired data to one of the plurality of host computers.

18. A method of implementing a data acquisition task over a network, wherein said network includes a host terminal and a plurality of peripheral devices that are linked via said network, said method comprising:
capturing one or more parameters at a host device, at least one of said one or more parameters being related to a data acquisition operation to be performed at one of said plurality of peripherals;
storing said one or more parameters at a data store associated with said host device;
retrieving, at said one peripheral, said one or more parameters from said data store;
performing said data acquisition operation at said one peripheral in accordance with said retrieved parameters; and
transferring said acquired data to said host device using a TWAIN protocol for use in an application running on said host device.
